(19) United States
(12) Patent Application Publication
(10) Pub. No.: US 2010/0170224 A1
(43) Pub. Date: Jul. 8, 2010

(54) PLASMA ENHANCED BOOSTER AND METHOD OF OPERATION

(75) Inventors: DAVID SCOTT CLARK, LIBERTY TOWNSHIP, OH (US); ASPI RUSTOM WADIA, LOVELAND, OH (US); CHING PANG LEE, CINCINNATI, OH (US); PETER JOHN WOOD, LOVELAND, OH (US)

Correspondence Address: GENERAL ELECTRIC COMPANY, GE AVIATION, ONE NEUMANN WAY MD F16, CINCINNATI, OH, 45215, US

(73) Assignee: GENERAL ELECTRIC COMPANY

(21) Appl. No.: 12/350,438

(22) Filed: Jan. 8, 2009

(51) Int. Cl. F02K 3/04

(52) U.S. Cl. 60/264

(57) ABSTRACT

A booster system is disclosed, comprising a first rotor stage having a plurality of first rotor blades spaced circumferentially around a rotor hub with a longitudinal axis and having a first pitch-line radius extending from the longitudinal axis, a last rotor stage located axially aft from the first rotor stage, the last rotor stage comprising a plurality of last rotor blades spaced circumferentially around the longitudinal axis and having a second pitch-line radius extending from the longitudinal axis, and a gooseneck duct located axially aft from the last rotor stage and capable of receiving an airflow, the gooseneck duct comprising an inlet end and an exit end located at a distance axially aft from the inlet end and having at least one plasma actuator mounted in the gooseneck duct.

### BACKGROUND OF THE INVENTION

This invention relates generally to compressors, and more specifically to a booster system having a transition duct having plasma actuators.

In a gas turbine engine, air is pressurized in a compression module during operation. The air channeled through the compression module is mixed with fuel in a combustor and ignited, generating hot combustion gases which flow through turbine stages that extract energy therefrom for powering the fan and compressor rotors and generate engine thrust to propel an aircraft in flight or to power a load, such as an electrical generator.

The compressor includes a rotor assembly and a stator assembly. The rotor assembly includes a plurality of rotor blades extending radially outward from a disk. More specifically, each rotor blade extends radially between a platform adjacent the disk, to a tip. A gas flowpath through the rotor assembly is bound radially inward by the rotor blade platforms, and radially outward by a plurality of shrouds.

The stator assembly includes a plurality of circumferentially spaced apart stator vanes or airfoils that direct the compressed gas entering the compressor to the rotor blades. The stator vanes extend radially between an inner band and an outer band. A gas flowpath through the stator assembly is bound radially inward by the inner bands, and radially outward by outer bands. The rotor stages comprise rotor blades arranged circumferentially around a rotor hub. Each compression stage comprises a vane stage and a rotor stage.

Modern high by-pass ratio gas turbine engines have a booster (low pressure compressor) and a high pressure compressor with a transition duct located in between. Conventional transition or gooseneck duct geometries are governed by their levels of endwall curvature, since excessive curvature leads to endwall boundary layer separation and therefore high losses in efficiency. To ensure a smooth aerodynamic transition without flow separation, conventional transition duct designs must have some minimum axial length for a given change in annular flow radius. This is not desirable because increased transition duct lengths translate directly to increased engine length, which in turn adds engine weight and reduces backbone stiffness of the engine. This reduction in stiffness makes it more difficult to maintain the desired clearances over the rotor tips, reducing the efficiency and operability range of the engine.

As compressor and booster rotors approach the limits of their capability to add work/pressure to the air, they tend to become less efficient and, if pushed beyond this limit, stall (fail to produce their required pressure rise, leading to reversed flow through the stage and a loss of engine thrust). A booster rotor that is designed very near to its limits in the rear stages of the booster could experience significant operability problems. This is a concern in conventional booster system designs which are limited to lower radii in the aft rotor stages. These could be corrected by pushing the back end of the booster outwards, as enabled by the use of plasma actuators in the transition duct.

Accordingly, it is would be desirable to have a shorter transition duct design having enhanced pressure distribution without causing flow separation in the duct. It would be desirable to have a booster system which has a higher radius for aft rotor stages without causing flow separation in the transition duct.

### BRIEF DESCRIPTION OF THE INVENTION

The above-mentioned needs may be met by exemplary embodiments which provide a booster system comprising a first rotor stage having a plurality of first rotor blades spaced circumferentially around a rotor hub with a longitudinal axis and having a first pitch-line radius extending from the longitudinal axis, a last rotor stage located axially aft from the first rotor stage, the last rotor stage comprising a plurality of last rotor blades spaced circumferentially around the longitudinal axis and having a second pitch-line radius extending from the longitudinal axis, and a gooseneck duct located axially aft from the last rotor stage and capable of receiving an airflow, the gooseneck duct comprising an inlet end and an exit end located at a distance axially aft from the inlet end and having at least one plasma actuator mounted in the gooseneck duct.

In another aspect of the present invention, the ratio of the second pitch-line radius and the first pitch-line radius is at least 0.9.

In another aspect of the present invention, a method of operating a gas turbine engine comprises the steps of forming a plasma along a wall in a gooseneck duct located axially aft from a booster rotor stage.

### BRIEF DESCRIPTION OF THE DRAWINGS

The subject matter which is regarded as the invention is particularly pointed out and distinctly claimed in the concluding part of the specification. The invention, however, may be best understood by reference to the following description taken in conjunction with the accompanying drawing figures in which:

FIG. 1 is a cross-sectional view of an exemplary gas turbine engine assembly comprising a compression system according to an exemplary embodiment of the present invention.

FIG. 2 is an enlarged axial cross-sectional view from FIG. 1 showing a portion of a booster system according to an exemplary embodiment of the present invention.

FIG. 3 is a schematic view of a gooseneck duct having plasma actuators according an exemplary embodiment of the present invention.

FIG. 4 is an enlarged axial cross sectional view of a portion of an exemplary duct having a plasma actuator system in the energized mode.

FIG. 5 is a schematic view of a gooseneck duct of a booster system according to an exemplary embodiment of the present invention.

FIG. 6 is a schematic view of a booster system having plasma actuators according to an exemplary embodiment of the present invention superimposed with a conventional booster flow path for comparison.

FIG. 7 is a plot of pressure distributions in a booster system according to an exemplary embodiment of the present invention when plasma actuators are energized and de-energized.

### DETAILED DESCRIPTION OF THE INVENTION

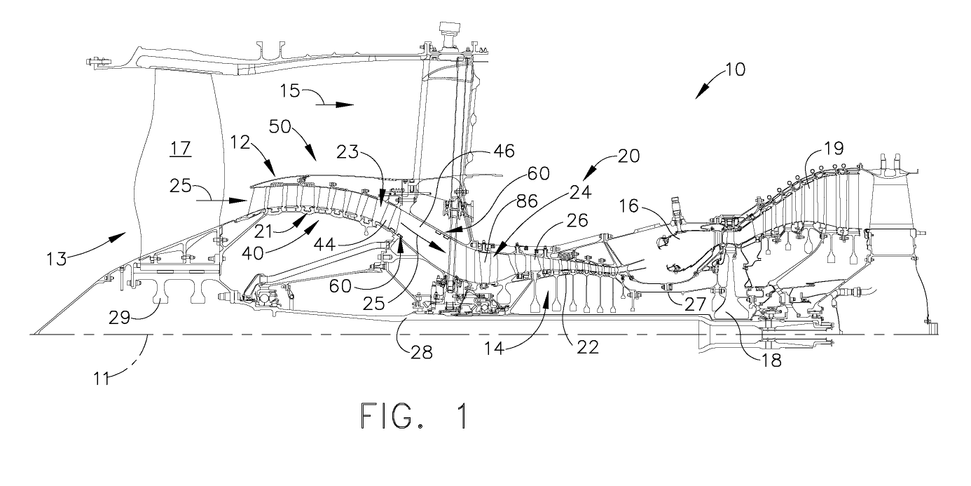

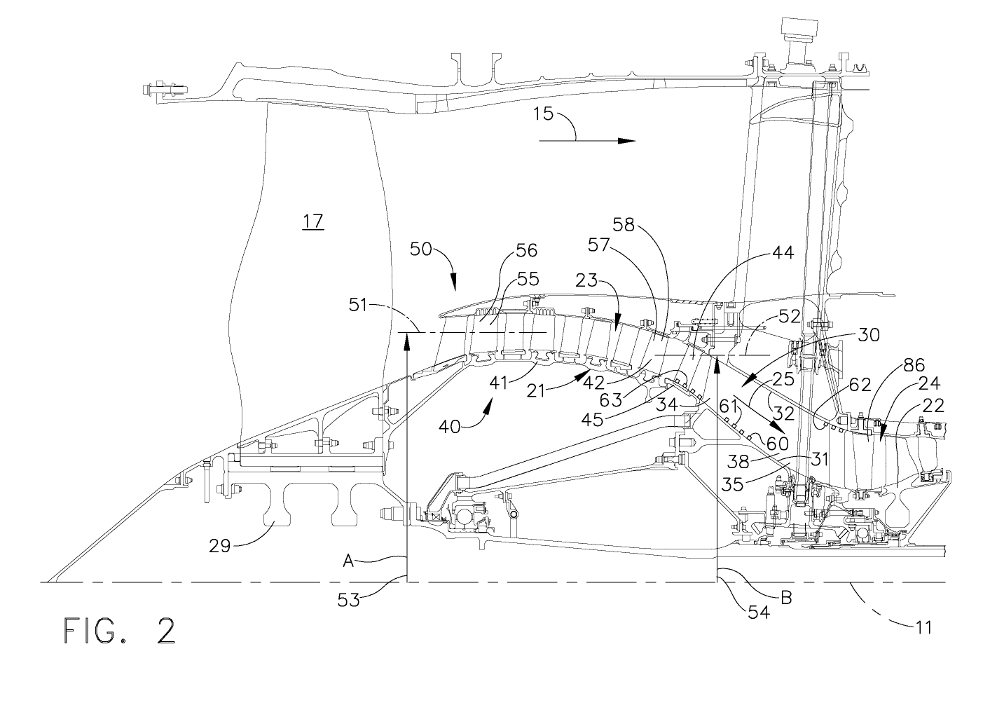

Referring to the drawings wherein identical reference numerals denote the same elements throughout the various views, FIG. 1 shows a cross-sectional view of an exemplary gas turbine engine assembly 10 having a longitudinal axis 11 and a compression system 20 comprising a first compressor 21 and a second compressor 22 that is located axially aft from the first compressor 21. In the exemplary embodiment shown in FIG. 1, the first compressor 21 is a booster 40, that is also referred to alternatively herein as a low-pressure compressor. The exemplary booster 40 shown in FIGS. 1 and 2 has four rotor stages, with each rotor stage having between 50 and 90 booster rotor blades. The exemplary booster system 50 has a row of stator vanes (alternatively referred to herein as booster inlet guide vanes “IGV”) located axially forward from the first booster rotor stage. The exemplary booster system 50 has a row of stator vanes (alternatively referred to herein as booster outlet guide vanes 44 “OGV”) located axially aft from the last booster rotor stage. The OGV 44 has 120 vanes circumferentially spaced around the longitudinal axis 11. Further, the second compressor 22 shown in FIG. 1 is an axial-flow high-pressure compressor 14 (“HPC”). The exemplary HPC 14 shown in FIGS. 1 and 2 has seven rotor stages, with each rotor stage having between 24 and 96 HPC rotor blades. The exemplary HPC 14 has a circumferential row of 40 stator vanes (alternatively referred to herein as HPC inlet guide vanes “IGV”) located axially forward from the first HPC rotor stage. The exemplary embodiment of the gas turbine engine assembly 10 shown in FIG. 1 further comprises a combustor 16, and a high-pressure turbine 18 and a low-pressure turbine 19 that is coupled axially downstream from core gas turbine engine 12, and a fan assembly 13 that is coupled axially upstream from core gas turbine engine 12. Fan assembly 13 includes an array of fan blades 17 that extend radially outward from a rotor disk 29. In the exemplary embodiment shown in FIG. 1, the fan assembly 13, the booster 40 and low-pressure turbine 19 are coupled together by a first rotor shaft 28, and compressor 14 and high-pressure turbine 18 are coupled together by a second rotor shaft 27.

In operation, air flows through fan assembly blades 17 and a portion of that air flows as bypass airflow 15 and a portion of the air flows as core airflow 25 into the compression system 20 that includes a first compressor 21 and a second compressor 22. In the exemplary embodiments shown in FIGS. 1 and 2, the first compressor 21 is a booster 40 (low pressure compressor) and the second compressor 22 is a high-pressure compressor 14. The core airflow 25 entering the compression system 20 is first channeled through a first flow path 23 and is compressed in the first compressor 21 (shown in the figures herein as booster 40). The core airflow 25 is then channeled through an arcuate third flowpath 33 in a duct 30 (alternatively referred to herein as a transition duct 30 or as a gooseneck duct 38) to a second flowpath 24 in the second compressor 22 (shown in the figures herein as a high-pressure compressor 14) wherein the core airflow 25 is further compressed. Airflow exiting from the compression system 20 is channeled to a combustor 16. Air is mixed with fuel in the combustor and burned. Products of combustion from combustor 16 are utilized to drive a high pressure turbine (HPT) 18 and a low pressure turbine (LPT) 19. In the exemplary embodiments shown herein, the LPT 19 drives the booster 40 and fan assembly 13 via fan rotor shaft 28 and the HPT drives the high-pressure compressor 14 via HP rotor shaft 27. Engine 10 is operable at a range of operating conditions between design operating conditions and off-design operating conditions. In the exemplary embodiments shown in FIGS. 1 and 2, the booster 40 rotor may have operating speeds between 1500 rpm and 2700 rpm, and the high-pressure compressor 14 rotor may have operating speeds between 6000 rpm and 12000 rpm.

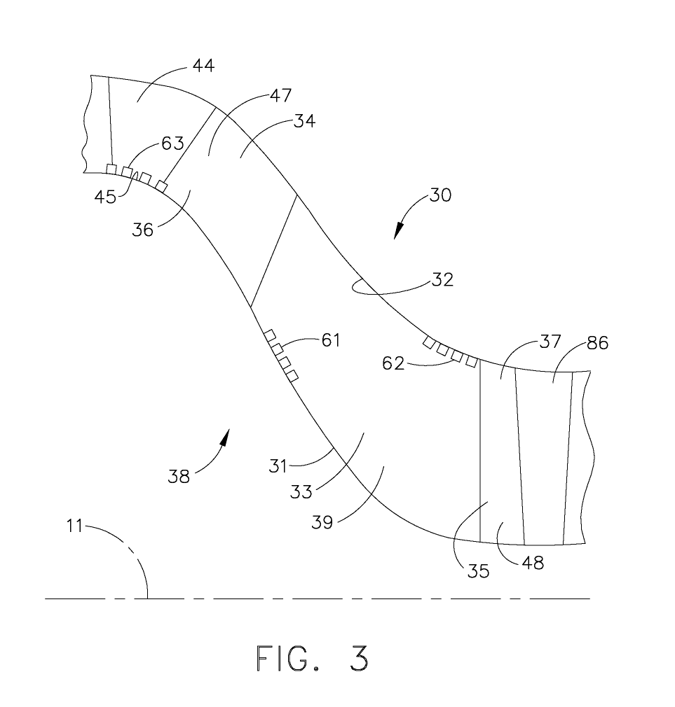

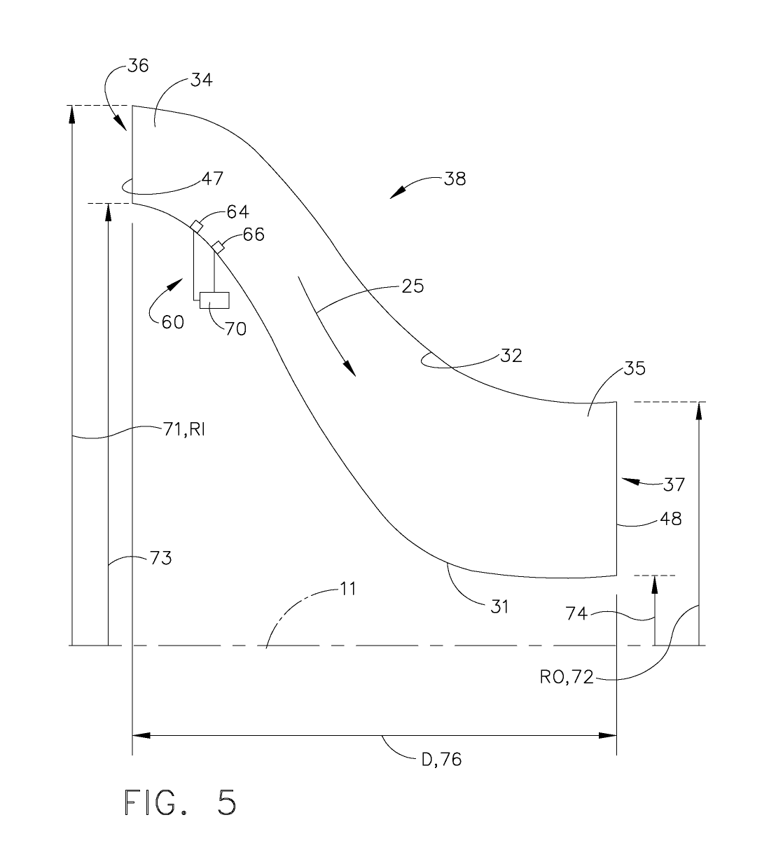

In the exemplary embodiments shown in FIGS. 1 and 2, the pitchlines of the booster rotor stages are located radially at a higher radius than the pitchlines of the high-pressure compressor rotor stages. This is especially true in the case of modern high bypass ratio engines. As used herein, “pitchline” of a rotor stage is defined as an axial line passing through the radial mid-point between the root and tip of the leading edge of the airfoil of a rotor blade in the rotor stage. The transition duct 30 flows the core airflow 25 from the first flowpath 23 of the booster 40 to the second flowpath 24 of the high-pressure compressor. FIGS. 3 and 5 show schematically an axial cross sectional view of an exemplary embodiment of a transition duct 30 according to the present invention. The terms “duct”, “transition duct” and “gooseneck duct” have the same meaning, and are used interchangeably herein. The duct 30 comprises an inlet portion 34 and an exit portion 35 that is located axially aft from the inlet portion. The inlet portion 34 has an inlet end 47 having an inlet area 36 and the exit portion 35 has an exit end 48 having an exit area 37. The inlet portion 34 is axially located near the booster 40 and the exit portion is axially located near the high-pressure compressor 14. The inlet portion 34 is located radially outward from the exit portion 35 and centerline axis 11. The duct 38 comprises an inner wall 31 and an outer wall 32 that form the flowpath 33 in between. The duct 38 may have an annular shape around the longitudinal axis 11. In the exemplary embodiments shown in FIGS. 1, 2 and 3, struts 46 of a support frame extend radially through the third flowpath 33 of the duct 38 at some circumferential locations. The third flow path has a generally annular shape with respect to the longitudinal axis 11 in the axial direction, with the struts 46 extending through it at certain circumferential locations in some applications. Due to the generally annular configuration of the duct 38 with the inlet portion 34 located radially outward from the exit portion 35, the third flow path 33 and the duct 38 have a gooseneck shape, such as shown, for example, in FIGS. 3 and 5. The inner wall 31 and the outer wall 32 have an arcuate shape in the axial direction, such as shown, for example, in FIGS. 3 and 5.

Referring to FIG. 5, the inlet end 47 of the duct 30 is located at a higher radius with respect to the longitudinal axis 11 than the exit end 48. The exit end 48 is located at an axial aft distance 76 (“D”) from the inlet end 47. In the exemplary embodiments of the present invention shown herein, the ratio of the inlet outer radius 71 (“RI”) to the exit outer radius 72 (“RO”) is about 1.8. For the same duct axial length D, this ratio is about 1.6 or less for conventional designs. In the exemplary embodiments shown herein, the axial distance D 76 is between about 16 inches and 18 inches. In the exemplary embodiments shown herein, the inlet area 36 is about 598 sq. inches and the exit area 37 is about 570 sq. inches. A slight reduction in the exit area 37 from the inlet area 36 may help to further reduce flow separation in the duct 38. In other embodiments of the present invention, the inlet area 36 and the exit area 37 may have other suitable values. In alternative embodiments, it may be advantageous to have the exit area 37 larger than the inlet area 36 to improve pressure distributions in the duct 38 using known design methods. The present invention enables the design of booster systems having short duct axial lengths (“D”) as compared to the inlet and exit radii (“RI” and “RO”). In the exemplary embodiments of the present invention, the aspect ratio, defined as the ratio (RI-RO)/D, is between about 0.5 and 0.8. Due to the geometric nature of the cross sectional shape of the third flowpath 33, such as shown in FIGS. 3 and 5, the transition duct 30 is alternatively referred to herein as a gooseneck duct 38.

As is evident from the exemplary embodiments shown herein, the inner wall 31 and outer wall 32 have significant curvatures in the axial direction. In the exemplary embodiments of the present invention shown in FIGS. 1, 2, 3, 5 and 6 flow separation in the duct 38 is reduced by using plasma actuators 60. The terms “plasma actuator” and “plasma generator” as used herein have the same meaning and are used interchangeably. The plasma actuators, such as for example, shown as items 60, 61, 62, and 63 in the figures herein, strengthen the local axial momentum of the airflow near the walls 31, 32 and minimize flow separation in the duct 30 in regions having sharp radius of curvature in the inner and outer walls 31, 32. Plasma actuators used as shown in the exemplary embodiments of the present invention, produce a stream of ions and a body force that act upon the fluid near the walls 31, 32, forcing it to flow closer to the walls 31, 32 in direction of the desired fluid flow with reduced flow separation from the walls 31, 32.

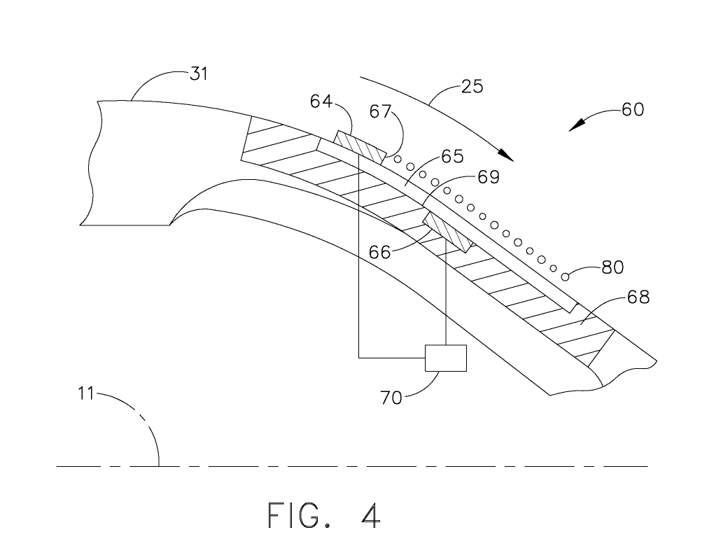

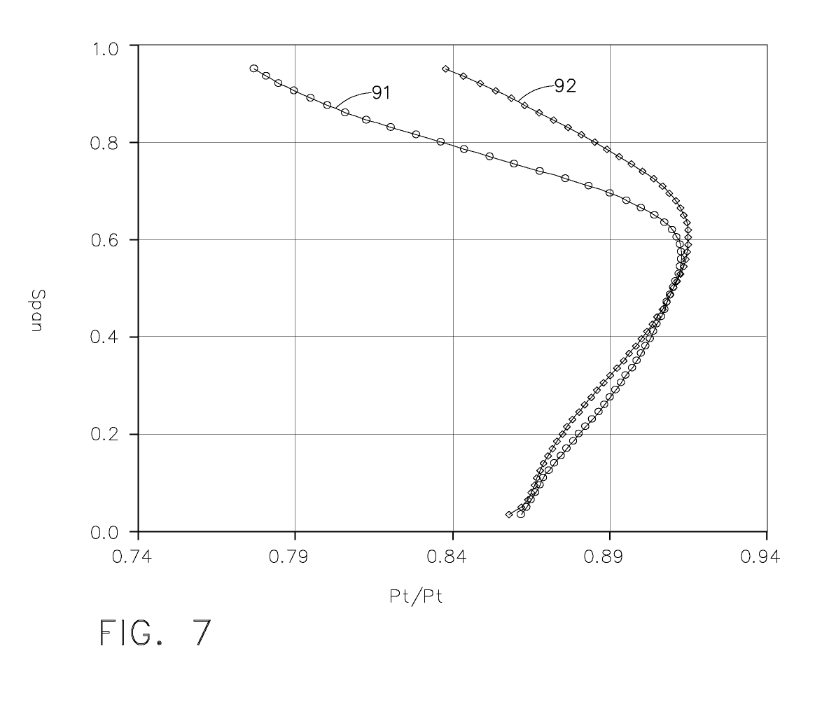

FIG. 4 schematically illustrates, in axial cross-section view, an exemplary embodiment of plasma actuator 60 for reducing the flow separation in a transition duct 38 located between two compressors, such as the booster 40 and the HPC 14 shown in FIGS. 1 and 2. The exemplary embodiments of the present invention shown herein facilitate an improvement of the pressure distribution in the duct 38 (see FIG. 7) and/or enhance the efficiency of compression systems, in a gas turbine engine 10 such as the aircraft gas turbine engine illustrated in cross-section in FIG. 1. The exemplary gas turbine engine plasma actuators shown in FIGS. 1-6 include plasma actuators, such as shown as items 60, 61, 62 or 63 located on the inner wall 31, outer wall 32 or the hub portion 45 of the booster OGV 44. The plasma actuator, such as item 60 shown in FIG. 4, is located in a groove 68 in a wall, such as the inner wall 31. The plasma actuator 60 may be continuous in the circumferential direction located in an annular groove. Alternatively, the plasma actuator 60 may be segmented wherein a plurality of plasma actuators 60 are located in corresponding groove segments spaced circumferentially in the walls 31, 32. The exemplary embodiment shown in FIG. 4 comprises a plasma actuator 60 located in a groove 68 in the inner wall 31 of the duct 38. Alternately, the plasma actuators 60 may be located at other locations in the duct 38 where flow separation is likely to occur, such as, for example, locations where the duct 38 walls have a sharp radius of curvature in the direction of airflow.

The exemplary embodiment shown in FIG. 4 shows an annular plasma generator 60 mounted to the inner wall 31 and includes a first electrode 64 and a second electrode 66 separated by a dielectric material 65. The dielectric material 65 is disposed within an annular groove 68 of the duct 38. An AC (alternating current) power supply 70 is connected to the electrodes 64, 66 to supply a high voltage AC potential in a range of about 3-20 kV to the electrodes 64, 66. When the AC amplitude is large enough, the air ionizes in a region of largest electric potential forming a plasma 80. The plasma 80 generally begins near an edge 67 of the first electrode 64 which is exposed to the air and spreads out over an area 69 projected by the second electrode 66 which is covered by the dielectric material 65. The plasma 80 (ionized air) in the presence of an electric field gradient produces a force on the airflow 25 near the wall 31 inducing a virtual aerodynamic shape that causes a change in the pressure distribution over the inner wall 31 of the annular duct 38. The air near the electrodes is weakly ionized, and usually there is little or no heating of the air. The airflow 25 near the wall 31 tends to remain attached to the wall 31 resulting in reduced flow separation and improved pressure distribution within the duct 38 due to reduced pressure loss in the duct 38.

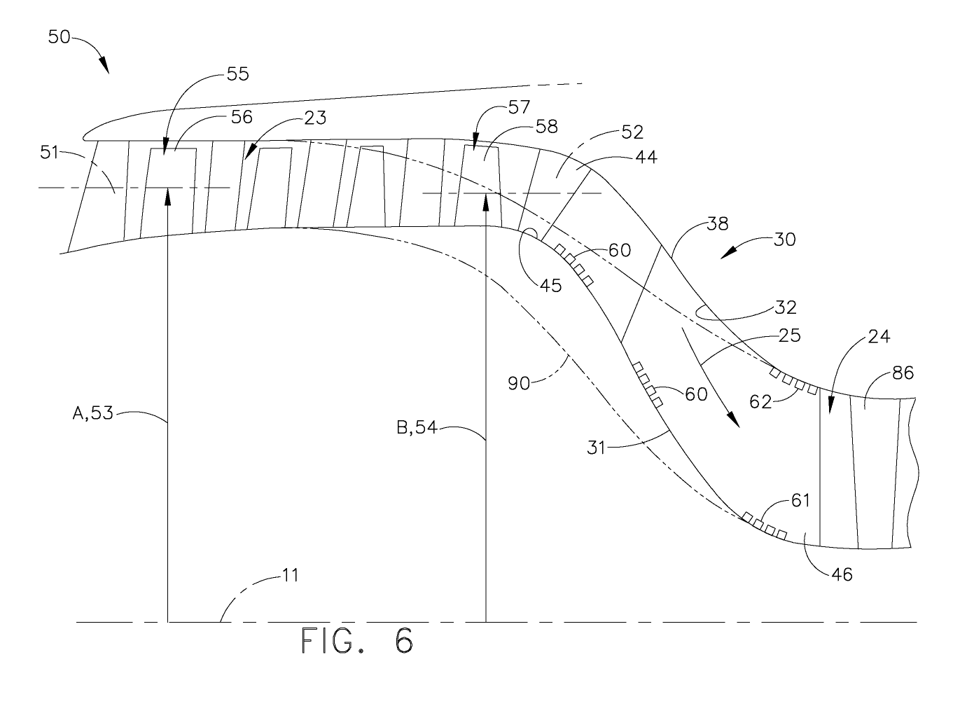

FIG. 6 shows a booster system 50 according to an exemplary embodiment of the present invention. The booster system 50 shown in FIG. 6 has a last rotor stage 57 having a pitchline radius 54 that is larger than conventional booster systems. This is made possible in the present invention by the use of plasma actuators, such as, for example, shown as items 60, 61, 62 in FIG. 6, in a duct 38 that receives the flow from the last stage of the booster. A conventional flowpath 90 of a conventional booster system is shown by dotted line in FIG. 6 for comparison with the exemplary embodiment of the present invention, booster system 50. There are several benefits associated with having the aft stages of the booster, such as the last rotor stage 57, radially further outward. The rotor stage 57, having a larger pitchline radius 54, has an increased tip speed compared to conventional designs. Since the ability of a rotor to do work on a fluid is directly related to its tangential velocity, the exemplary embodiment of the present invention shown in FIG. 6 has increased capacity to produce pressure rise. In some applications, for a desired pressure ratio, it is possible to reduce the number of required stages in a booster system by using the present invention resulting in significantly reduced weight for the engine 10.

In the exemplary embodiment of the present invention shown in FIG. 6, the booster system 50 has a first rotor stage 55 comprising a plurality of first rotor blades 56 spaced circumferentially around a rotor hub 41 and having a first pitch-line radius 53 extending from the longitudinal axis 11, a last rotor stage 57 located axially aft from the first rotor stage 55. The last rotor stage 57 has a plurality of last rotor blades 58 spaced circumferentially around the rotor hub 41 and has a second pitch-line radius 54 extending from the longitudinal axis 11. The booster system has a gooseneck duct 38 located axially aft from the last rotor stage 57 and receives the airflow 25 exiting from the last rotor stage 57. The gooseneck duct 38 has an inlet end 47, an exit end 48 located at a distance axially aft from the inlet end 47, and has at least one plasma actuator mounted in the gooseneck duct 38. The geometry of the gooseneck duct 38 and the placement of the plasma actuators, such as for example, shown as items 60, 61, 62 in FIG. 6, are described previously herein. Unlike conventional booster systems, the last rotor stage 57 has a higher pitchline radius 54 “B” as compared to the first rotor stage 55 pitchline radius 53 “A”. In the exemplary embodiments of the present invention shown herein, the ratio B/A is at least 0.9.

The exemplary booster system 50 shown in FIG. 6 has a gooseneck duct 38 located at the aft end, the duct 38 having an axially arcuate inner wall 31 and an axially arcuate outer wall 32. The exit end 48 has an exit area 37 and the inlet end 47 has an inlet area 36. The geometry of the gooseneck duct (see FIG. 5) is such that the ratio RI/RO of the inlet outer radius 71 to the exit outer radius 72 is at least 1.6. Plasma actuators, such as for example, shown as items 60, 61, 62 in FIG. 6 are located in the duct 38 as described previously herein.

A gas turbine engine 10 having a booster system 50 with the gooseneck duct 38 having plasma actuators as described herein, can be operated by energizing the first electrode 64 and second electrode 66 using the AC potential from the AC power supply 70. By energizing the electrodes 64, 66 and creating the plasma 80, flow separation in the duct 38 can be reduced which results in the advantages and improvements in pressure distributions in the booster system 50. In one method, the plasma actuators, such as item 60 in FIG. 6, can be energized continuously throughout engine operation period. Alternatively, the plasma actuators can be energized only during selected portions of the engine operating regime. The periods and durations of plasma actuator energization can be determined by known engine test methods for determining engine operability.

FIG. 7 shows an exemplary pressure distribution within the duct 38 at the exit end 48 determined by known fluid flow analytical methods. The horizontal axis shows the normalized pressure and the vertical axis shows the radial span locations within the duct 38. The distribution identified by numeral 91 shows the radial pressure distribution at the exit end 48 of the duct 38 when the plasma actuator 60 is not energized by the AC power supply 70. The distribution identified by numeral 92 shows the radial pressure distribution at the same location (exit end 48 of the duct 38) when the plasma actuator 60 is energized by the AC power supply 70. It is clear that near the wall 32 (near the 1.0 span location) wherein the plasma actuator is located, the normalized pressure increases from about 0.79 to about 0.86.

As used herein, an element or step recited in the singular and proceeded with the word “a” or “an” should be understood as not excluding plural said elements or steps, unless such exclusion is explicitly recited. When introducing elements/components/steps etc. of designing and/or manufacturing components and systems described and/or illustrated herein, the articles “a”, “an”, “the” and “said” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Furthermore, references to “one embodiment” of the present invention are not intended to be interpreted as excluding the existence of additional embodiments that also incorporate the recited features.

Although the methods and articles such as vanes, outer bands, inner bands and vane segments described herein are described in the context of a compressor used in a turbine engine, it is understood that the vanes and vane segments and methods of their manufacture or repair described herein are not limited to compressors or turbine engines. The vanes and vane segments illustrated in the figures included herein are not limited to the specific embodiments described herein, but rather, these can be utilized independently and separately from other components described herein.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While there have been described herein what are considered to be preferred and exemplary embodiments of the present invention, other modifications of the invention shall be apparent to those skilled in the art from the teachings herein, and it is, therefore, desired to be secured in the appended claims all such modifications as fall within the true spirit and scope of the invention.

What is claimed is:

1. A booster system comprising:
a first rotor stage comprising a plurality of first rotor blades spaced circumferentially around a rotor hub with a longitudinal axis and having a first pitch-line radius extending from the longitudinal axis;
a last rotor stage located axially aft from the first rotor stage, the last rotor stage comprising a plurality of last rotor blades spaced circumferentially around the longitudinal axis and having a second pitch-line radius extending from the longitudinal axis; and
a gooseneck duct located axially aft from the last rotor stage and capable of receiving an airflow, the gooseneck duct comprising an inlet end and an exit end located at a distance axially aft from the inlet end and having at least one plasma actuator mounted in the gooseneck duct.

2. A booster system according to claim 1 wherein the ratio of the second pitch-line radius and the first pitch-line radius is at least 0.9.

3. A booster system according to claim 1 wherein the gooseneck duct comprises an axially arcuate inner wall and an axially arcuate outer wall, an inlet outer radius extending between the longitudinal axis and the outer wall at the inlet end and an exit outer radius extending between the longitudinal axis and the outer wall at the exit end, the ratio of the inlet outer radius to the exit outer radius is at least 0.9.

4. A booster system according to claim 3 wherein the ratio of the second pitch-line radius and the first pitch-line radius is at least 0.9.

5. A booster system according to claim 2 wherein the inlet end has an inlet area and the exit end has an exit area that is greater than the inlet area.

6. A booster system according to claim 2 wherein the at least one plasma actuator is located on the inner wall.

7. A booster system according to claim 2 wherein the at least one plasma actuator is located on the outer wall.

8. A booster system according to claim 2 further comprising an outlet guide vane located between the last rotor stage and the gooseneck duct wherein the outlet guide vane extends radially outward from a hub portion having a plasma actuator located on the hub portion.

9. A booster system according to claim 2 wherein the plasma actuator is continuous in a circumferential direction around a longitudinal axis.

10. A booster system according to claim 2 further comprising a plurality of plasma actuators arranged in a circumferential direction around a longitudinal axis.

11. A booster system according to claim 2 wherein the plasma actuator comprises a first electrode and a second electrode separated by a dielectric material.

12. A booster system according to claim 11 further comprising an AC power supply connected to the first electrode and the second electrode to supply a high voltage AC potential to the first electrode and the second electrode.

13. A method of operating a gas turbine engine comprising a booster system having a plasma actuator, the method comprising the steps of forming a plasma along a wall in a gooseneck duct located axially aft from a booster rotor stage.

14. A method according to claim 13 further comprising supplying an AC potential to a first electrode and a second electrode separated by a dielectric material.

15. A method according to claim 14 further comprising supplying the AC potential continuously to the first electrode and the second electrode.

16. A method according to claim 14 further comprising cutting off the AC potential during a selected portion of the engine operating range.

17. A method according to claim 13 further comprising selectively energizing a plurality of plasma actuators by supplying an AC potential to a plurality of electrodes.

18. A method according to claim 13 wherein the booster system comprises a first pitch-line radius for a first rotor stage and a second pitch-line radius for a last rotor stage located axially aft from the first rotor stage wherein the ratio of the second pitch-line radius and the first pitch-line radius is at least 0.9.
